(19) United States
(12) Patent Application Publication
(10) Pub. No.: US 2016/0203808 A1
(43) Pub. Date: Jul. 14, 2016

(54) BELL BOTTOM BEVERAGEWARE

(71) Applicant: Kirk Weber, Houston, TX (US)

(72) Inventor: Kirk Weber, Houston, TX (US)

(21) Appl. No.: 14/992,910

(22) Filed: Jan. 11, 2016

Related U.S. Application Data
(60) Provisional application No. 62/101,588, filed on Jan. 9, 2015.

(51) Int. Cl. G10K 1/071; B29C 65/48; G10K 1/072

(52) U.S. Cl. CPC G10K 1/071; G10K 1/072; B29C 65/48; B29L 2031/7132

(57) ABSTRACT

Bell bottom beverageware. The bell bottom beverageware includes a cup, the cup including a vessel configured to contain a liquid. The bell bottom beverageware also includes a bell. The bell is attached to the bottom of the cup and acts as a base thereof. The bell bottom beverageware further includes a striking implement, configured to ring the bell.

### CROSS-REFERENCE TO RELATED APPLICATIONS

This application claims the benefit of and priority to U.S. Provisional Patent Application Ser. No. 62/101,588 filed on Jan. 9, 2015, which application is incorporated herein by reference in its entirety.

### BACKGROUND OF THE INVENTION

Stemware is beverageware that stands on stems above a base. It is usually made from glass, but may be made from ceramics or metals. Stemware includes, but is not limited to, champagne flutes, chalices and goblets, cocktail glasses (including martini glasses and margarita glasses), liqueur glasses, rummers, snifters, wine glasses. Traditionally stemware is a single item, such as glass.

Accordingly, there is a need in the art for stemware and other beverageware that includes a base that includes decorative material that is separate from the cup portion of the beverageware.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes bell bottom beverageware. The bell bottom beverageware includes a cup, the cup including a vessel configured to contain a liquid. The bell bottom beverageware also includes a bell. The bell is attached to the bottom of the cup and acts as a base thereof. The bell bottom beverageware further includes a striking implement, configured to ring the bell.

Another example embodiment includes a method of manufacturing bell bottom beverageware. The method includes providing a cup, the cup including a vessel configured to contain a liquid. The method also includes providing a bell. The bell is attached to a bottom of the cup and acts as a base thereof.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of bell bottom beverageware; and

FIG. 2 is a flow chart illustrating a method of manufacturing bell bottom beverageware.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

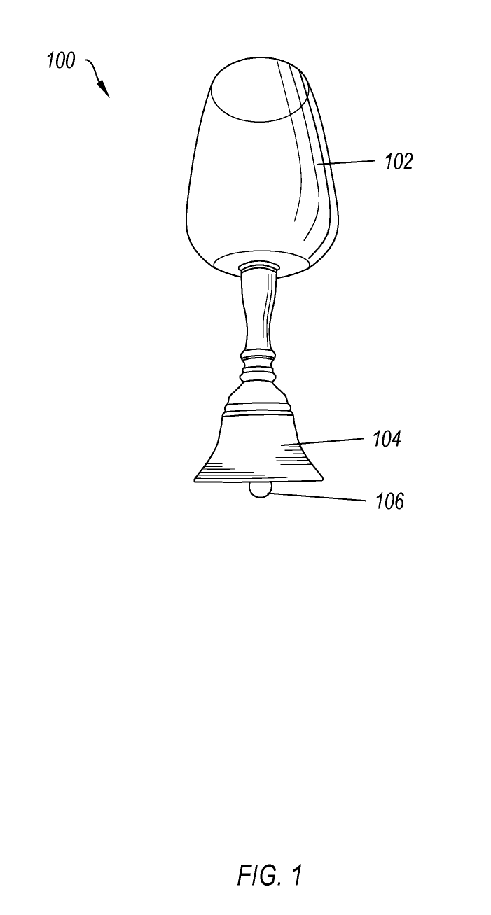

FIG. 1 illustrates an example of bell bottom beverageware 100. The bell bottom beverageware 100 can be used as a vessel for holding a drink by a user. The bell bottom beverageware 100 can create a sound during use or be silenced, depending on the preference of the user.

FIG. 1 shows that the bell bottom beverageware 100 includes a cup 102. A cup 102 is a general term for a vessel intended to contain beverages or liquid foods, generally for drinking or consumption. I.e., the cup 102 is a receptacle that contains some liquid. A user may then use the cup 102 to drink or otherwise consume the liquid contained within the cup 102. For example, the cup 102 can include a drinking glass or cup, glassware, stemware, barware, etc.

The cup 102 can include any desired material. For example, the cup 102 can include glass, plastic, crystal, ceramic or any other desired material. Additionally or alternatively, the cup 102 can include colors or patterns if so desired. For example, the cup 102 can be transparent or translucent. The cup 102 can be created specifically for use in bell bottom beverageware 100 or can be an existing cup—modified or unmodified—to be used in bell bottom beverageware 100.

FIG. 1 also shows that the bell bottom beverageware 100 includes a bell 104. The bell 104 may remain functional, even though attached to the bottom of the cup 102. I.e., the bell 104 (regardless of material; whether brass, glass, plastic, etc., and with or without handle) is the base and stem, or solely the base of the cup 102 to stand the vessel upright. The bell 104 is a simple sound-making device. In particular, the bell 104 is a percussion instrument. Its form is usually a hollow, cup-shaped acoustic resonator, which vibrates upon being struck. Bells are usually made of cast metal, but small bells can also be made from ceramic, plastic or glass.

The bell 104 can be created specifically for use in bell bottom beverageware 100 or can be an existing bell—modified or unmodified—to be used in bell bottom beverageware 100. Likewise, the bell 104 can be created as part of the cup 102 or attached later to the cup 102. I.e., the bell 104 and cup 102 can be created in a single step or can be manufactured separately then joined together after manufacture. The attachment of the bell 104 to the cup 102 can be accomplished using adhesive or any other desired method.

FIG. 1 further shows that the bell bottom beverageware 100 can include a striking implement 106. The striking implement 106 can be a tongue suspended within the bell, known as a clapper or uvula, a separate mallet or hammer, or—in small bells—a small loose sphere enclosed within the body of the bell. The striking implement 106 may include the same material as the bell 104 or include a different material. The striking implement 106 may be attached or may be provided separately for later attachment by a user if so desired. Additionally or alternatively, the striking implement 106 can be removable, allowing the user to attach the striking implement 106 when sound is desired and to remove the striking implement 106 when no sound is desired.

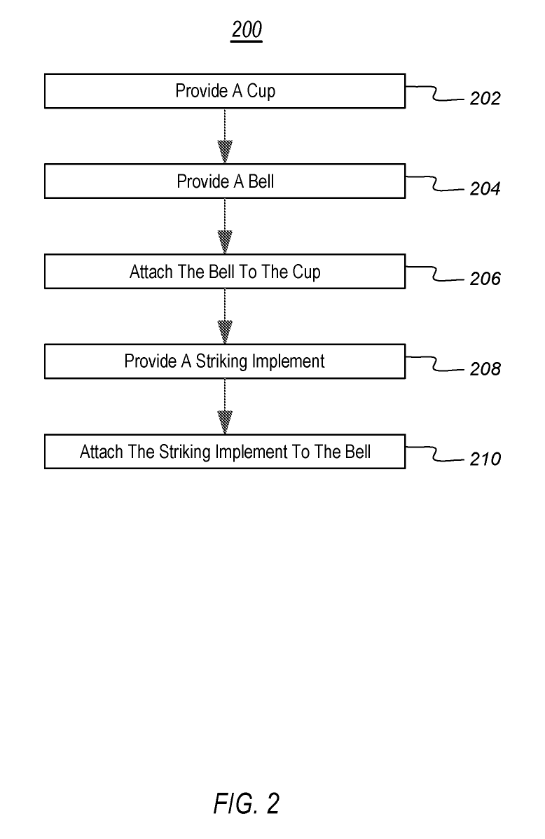

FIG. 2 is a flow chart illustrating a method 200 of manufacturing bell bottom beverageware. In at least one implementation, the bell bottom beverageware can be the bell bottom beverageware 100 of FIG. 1. Therefore, the method 200 will be described, exemplarily, with reference to the bell bottom beverageware 100 of FIG. 1. Nevertheless, one of skill in the art can appreciate that the method 200 can be used to produce bell bottom beverageware other than the bell bottom beverageware 100 of FIG. 1.

FIG. 2 shows that the method 200 can include providing 202 a cup. A cup 102 is a general term for a vessel intended to contain beverages or liquid foods, generally for drinking or consumption. I.e., the cup is a receptacle that contains some liquid. A user may then use the cup to drink or otherwise consume the liquid contained within the cup. For example, the cup can include a drinking glass or cup, glassware, stemware, barware, etc.

The cup can include any desired material. For example, the cup can include glass, plastic, crystal, ceramic or any other desired material. Additionally or alternatively, the cup can include colors or patterns if so desired. For example, the cup can be transparent or translucent. The cup can be created specifically for use in bell bottom beverageware or can be an existing cup—modified or unmodified—to be used in bell bottom beverageware.

FIG. 2 also shows that the method 200 can include providing 204 a bell. The bell may remain functional, even though attached to the bottom of the cup. I.e., the bell (regardless of material; whether brass, glass, plastic, etc., and with or without handle) is the base and stem, or solely the base of the cup to stand the vessel upright. The bell is a simple sound-making device. In particular, the bell is a percussion instrument. Its form is usually a hollow, cup-shaped acoustic resonator, which vibrates upon being struck. Bells are usually made of cast metal, but small bells can also be made from ceramic, plastic or glass. The bell can be created specifically for use in bell bottom beverageware or can be an existing bell—modified or unmodified—to be used in bell bottom beverageware.

FIG. 2 further that the method 200 can include attaching 206 the bell to the cup. Likewise, the bell can be created as part of the cup or attached later to the cup. I.e., the bell and cup can be created in a single step or can be manufactured separately then joined together after manufacture. The attachment of the bell to the cup can be accomplished using adhesive or any other desired method.

FIG. 2 additionally shows that the method 200 can include providing 208 a striking implement. The striking implement can be a tongue suspended within the bell, known as a clapper or uvula, a separate mallet or hammer, or—in small bells—a small loose sphere enclosed within the body of the bell. The striking implement may include the same material as the bell or include a different material.

FIG. 2 further that the method 200 can include attaching 206 the striking implement to the bell. The striking implement may be attached or may be provided separately for later attachment by a user if so desired. Additionally or alternatively, the striking implement can be removable, allowing the user to attach the striking implement when sound is desired and to remove the striking implement when no sound is desired.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Bell bottom beverageware, the bell bottom beverageware comprising:
a cup, the cup including a vessel configured to contain a liquid;
a bell, wherein the bell is:
attached to a bottom of the cup; and
acts as a base thereof; and
a striking implement, configured to ring the bell.

2. The bell bottom beverageware of claim 1, wherein the cup includes glass.

3. The bell bottom beverageware of claim 1, wherein the cup includes plastic.

4. The bell bottom beverageware of claim 1, wherein the cup includes crystal.

5. The bell bottom beverageware of claim 1, wherein the cup includes ceramic.

6. The bell bottom beverageware of claim 1, wherein the bell includes metal.

7. The bell bottom beverageware of claim 1, wherein the bell includes brass.

8. The bell bottom beverageware of claim 1, wherein the bell includes ceramic.

9. The bell bottom beverageware of claim 1, wherein the bell includes plastic.

10. The bell bottom beverageware of claim 1, wherein the cup and the bell are a single element.

11. The bell bottom beverageware of claim 1, wherein the cup and the bell are attached to one another using an adhesive.

12. The bell bottom beverageware of claim 1, wherein the striking implement is permanently attached to the bell.

13. The bell bottom beverageware of claim 1, wherein the striking implement is releasably attached to the bell.

14. A method of manufacturing bell bottom beverageware, the method comprising:
providing a cup, the cup including a vessel configured to contain a liquid; and
providing a bell, wherein the bell is:
attached to a bottom of the cup; and
acts as a base thereof.

15. The method of claim 14, further comprising:
providing a striking implement, configured to ring the bell.

16. The method of claim 14, further comprising:
attaching the striking implement to the bell.

17. The method of claim 14, wherein the cup and the bell are a single element.

18. The method of claim 14, wherein the cup and the bell are attached to one another using an adhesive.

19. The method of claim 14, further comprising:
removing the stem of the bell prior to attachment of the bell to the cup.
